(19) United States
(12) Patent Application Publication
(10) Pub. No.: US 2013/0099488 A1
(43) Pub. Date: Apr. 25, 2013

(54) O-RING SHIELD SYSTEM AND METHOD

(71) Applicants: Ricky Gov, El Monte, CA (US); Ron Friestad, LaVerne, CA (US); Peter Zheng, Rancho Palos Verdes, CA (US)

(72) Inventors: Ricky Gov, El Monte, CA (US); Ron Friestad, LaVerne, CA (US); Peter Zheng, Rancho Palos Verdes, CA (US)

(73) Assignee: HONEYWELL INTERNATIONAL INC., MORRISTOWN, NJ (US)

(21) Appl. No.: 13/277,882

(22) Filed: Oct. 20, 2011

(51) Int. Cl. F16L 21/035; B23P 11/00

(52) U.S. Cl. 285/374; 29/428

(57) ABSTRACT

An O-ring shield system and method of protecting O-rings in a high pressure refrigerant system are disclosed. The system may include first and second pipes coupled together. An O-ring may be disposed on one of the pipes. A compressible shield ring may be positioned upstream a flow of refrigerant from the O-ring.

### BACKGROUND OF THE INVENTION

The present invention generally relates to refrigerant systems and more particularly, to an O-ring shield system and method.

A common industry practice is to seal refrigerant system component joints using a radial type O-ring. The O-ring is typically placed in a gland (O-ring groove) that is machined in to the male fitting. The ring is then inserted into a female fitting where the O-ring is compressed between the inner diameter of the female fitting and the bottom of the groove. After the engagement, both halves (male and female fittings) are bolted together. Constant high pressure may damage the O-ring. Additionally, the refrigerant may contaminate the O-rings compromising the structure of the O-ring. Compromised O-rings may permit refrigerant to leak into undesirable portions of the pressurized system causing costly diagnosis and repair.

As can be seen, there is a need for a system that protects O-rings in high pressure refrigerant systems from damage and contamination.

### SUMMARY OF THE INVENTION

In one aspect of the present invention, an O-ring shield system comprises a first pipe; a second pipe including one or more circumferential grooves positioned on an exterior surface of the second pipe; one or more O-rings disposed in the one or more circumferential grooves; and a shield ring at a joint of the first pipe and the second pipe, the shield ring being compressible under a predetermined pressure, the shield ring positioned upstream a flow of refrigerant of the one or more O-rings.

In another aspect of the present invention, an O-ring shield system comprises a first pipe including a threaded female boss; a second pipe including a threaded male boss configured for receipt in the female boss, the second pipe further including one or more grooves positioned on an exterior surface of the second pipe; a beveled surface on an end of the male boss; one or more O-rings disposed in the one or more grooves, wherein the O-rings are disposed to be torqued into position within the female boss; and a shield ring over the beveled surface, the shield ring being compressible under a predetermined pressure, and the shield ring positioned upstream a flow of refrigerant of the one or more O-rings.

In still yet another aspect of the present invention, a method of protecting an O-ring in a refrigerant system includes determining the pressure in the refrigerant system will exceed a predetermined threshold; providing a shield ring that will compress under the determined pressure without breaking; positioning the selected shield ring upstream of the O-ring.

These and other features, aspects and advantages of the present invention will become better understood with reference to the following drawings, description and claims.

### BRIEF DESCRIPTION OF THE DRAWINGS

FIG. 1 is a cross-sectional view of an O-ring shield system in accordance with an exemplary embodiment of the present invention; and

FIG. 2 is a series of steps of a method in accordance with an exemplary embodiment of the present invention.

### DETAILED DESCRIPTION OF THE INVENTION

The following detailed description is of the best currently contemplated modes of carrying out the invention. The description is not to e taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

The present invention generally provides a layer of protection for gaskets. In one aspect, gaskets, for example, O-rings in high pressure aerospace-based refrigerant systems may be protected from rapid pressure changes. Exemplary aerospace-based refrigerant systems that may benefit from aspects of the following disclosure may include those using liquid and oil mixed refrigerants. In high pressure refrigerant systems O-rings may be permeable, thus inclined to absorbing refrigerant. Contamination of an O-ring with refrigerant may cause leaks and in some cases, may result in explosive decompression of the O-ring during rapid changes in pressure in the system.

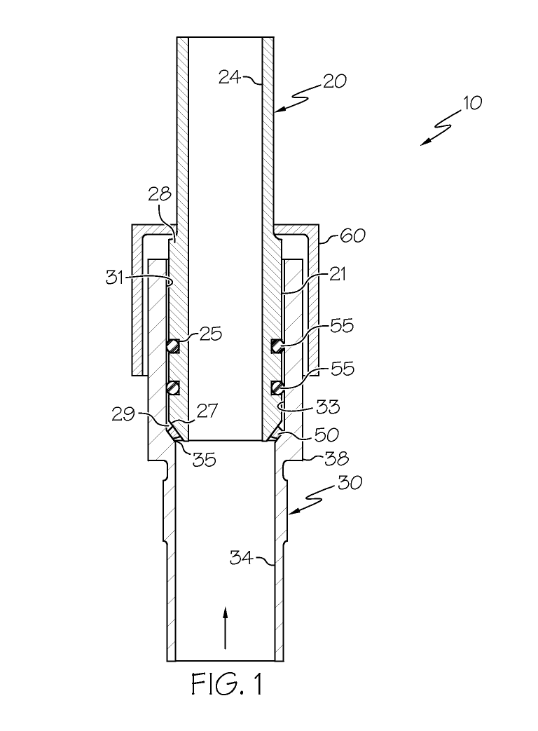

Referring to FIG. 1, an exemplary embodiment of an O-ring shield system 10 is shown. The O-ring shield system may include a pipe 20 and pipe 30 coupled together by a fastener 60. The O-ring shield system 10 may also include one or more O-rings 55 and a shield ring 50. In the O-ring shield system 10, the flow of refrigerant is flowing through pipe interior walls 34 and 24 from pipe 30 to pipe 20. Thus, in one exemplary embodiment, the O-ring shield 50 is positioned upstream of the O-rings 55.

In an exemplary embodiment of the O-ring shield system 10, the pipe 20 may include a male boss 28 and the pipe 30 may include a female boss 38. The male boss 28 may include a threaded exterior surface 21 configured for within a threaded interior surface 31 of female boss 38. The male boss 28 may include circumferential grooves or glands 25 adapted to receive the O-rings 55. The male boss 28 may also include a beveled end 27. The female boss 38 may include a beveled seat surface 35 configured to complement the beveled end 27 when the male boss 28 is coupled to the female boss 38. When coupled, the exterior surface 21 and interior surface 31 may define an inclined-plane passage 33 between the beveled end 27 and the O-rings 55. The beveled end 27 and the beveled seat 35 may be spaced apart. The O-ring shield ring 50 may be positioned between the beveled end 27 and the beveled seat 35. A gap 29 may be defined by the spacing between the O-ring shield ring 50 and the beveled end 27. The gap 29 may be in communication with the passage 33.

The O-ring shield ring 50 may be, for example, a washer selected from compressible material that may deform under predetermined pressure. For example, the O-ring shield ring 50 may be made of material that will decompress under pressures of approximately 600 pounds per square inch (psi) without breaking. One exemplary material used may be copper. The O-ring shield 50 may also be configured to withstand pressure changes of approximately 100 psi/sec. In one exemplary embodiment, coupling the male boss 28 into the female boss 38 may provide torque onto the O-ring shield ring 50 engaging the O-ring shield ring 50 onto the beveled end 27 and the beveled seat 35. During rapid pressure changes for example, pressure drops, the O-ring shield ring 50 may deform and at least partially fill the gap 29 while maintaining a barrier between the passage 33 and pipe interior wall 34.

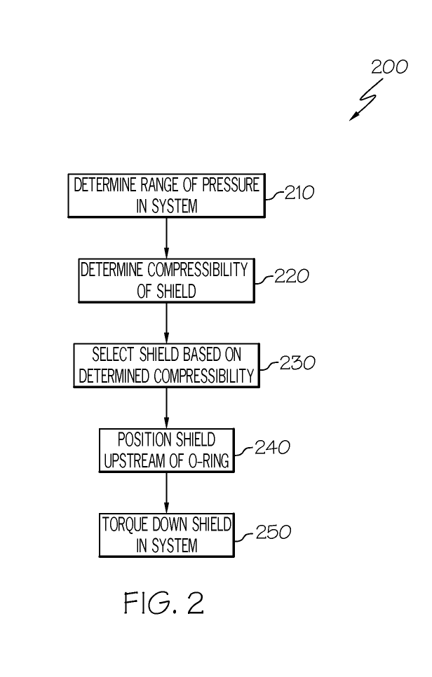

Referring now to FIG. 2, a method 200 is shown in accordance with an exemplary embodiment of the present invention. A system employing aspects in accordance with the disclosure may be analyzed for a range of typical operating pressure. The upper and lower threshold limits of operating pressure may be determined in step 210. An exemplary operating pressure in the system may be in the range of approximately 8-350 pounds per square inch absolute (psia). In step 220, compressibility of a material suitable in the system may be determined based on the threshold operating pressure limits determined in step 210. In step 230 a shield ring may be selected that includes the material with suitable compressibility determined in step 220. The selected shield may then be positioned in a boss end of a pipe of the system so that the shield ring is within a fluid flow, upstream of an O-ring (step 240). The boss end of the pipe may be coupled to an adjoining pipe end and torqued into place so that a torque pressure is applied to the shield ring (Step 250).

It should be understood, of course, that the foregoing relates to exemplary embodiments of the invention and that modifications may be made without departing from the spirit and scope of the invention as set forth in the following claims.

1. An O-ring shield system, comprising:
a first pipe;
a second pipe including one or more circumferential grooves positioned on an exterior surface of the second pipe;
one or more O-rings disposed in the one or more circumferential grooves; and
a shield ring at a joint of the first pipe and the second pipe, the shield ring being compressible under a predetermined pressure, the shield ring positioned upstream a flow of refrigerant of the one or more O-rings.

2. The O-ring shield system of claim 1 wherein:
the first pipe includes a female boss on an end of the first pipe; and
the second pipe includes a male boss on an end of the second pipe, the male boss connected to the female boss, wherein the circumferential grooves are disposed on an exterior surface of the male boss.

3. The O-ring shield system of claim 2 wherein the female boss includes a beveled seat disposed to receive the shield ring.

4. The O-ring shield system of claim 3 wherein the male boss includes a beveled end configured complementary to the beveled seat wherein the beveled end is disposed spaced from the beveled seat.

5. The O-ring shield system of claim 4 wherein the shield ring is disposed between the beveled end and the beveled seat.

6. The O-ring shield system of claim 5 wherein the shield ring and the beveled end define a gap between each other.

7. The O-ring shield system of claim 6 wherein the shield ring is configured to deform and fill in the gap.

8. An O-ring shield system, comprising:
a first pipe including a threaded female boss;
a second pipe including a threaded male boss configured for receipt in the female boss, the second pipe further including one or more grooves positioned on an exterior surface of the second pipe;
a beveled surface on an end of the male boss;
one or more O-rings disposed in the one or more grooves, wherein the O-rings are disposed to be torqued into position within the female boss; and
a shield ring over the beveled surface, the shield ring being compressible under a predetermined pressure, and the shield ring positioned upstream a flow of refrigerant of the one or more O-rings.

9. The O-ring shield system of claim 8 wherein the shield ring is spaced from the beveled surface defining a gap between the beveled surface and the shield ring.

10. The O-ring shield system of claim 9 wherein the shield ring is configured to deform under the predetermined pressure and fill in the gap.

11. A method of protecting an O-ring in a refrigerant system, including:
determining a pressure in the refrigerant system that will exceed a predetermined threshold;
providing a shield ring that will compress under the determined pressure without breaking; and
positioning the shield ring upstream of the O-ring.

12. The method of claim 11 including providing a gap between the shield ring and an end of a pipe holding the O-ring, wherein the gap is filled by the shield ring when compressed.

13. The method of claim 11 wherein the shield ring is selected from a metal rated compressible under approximately 600 pounds per square inch of pressure or greater.
